(19) United States
(12) Patent Application Publication
(10) Pub. No.: US 2005/0027609 A1
(43) Pub. Date: Feb. 3, 2005

(54) Interacting ordering method with function of re-directing returning profits

(76) Inventor: Hsing Yue Chane, Taoyuan (TW)

Correspondence Address: Hsing Yue Chane, 235 Chung-Ho, Box 8-24, Taipei, TW

(21) Appl. No.: 10/757,150

(22) Filed: Jan. 15, 2004

(30) Foreign Application Priority Data
Jul. 28, 2003 (TW) 92120479

(51) Int. Cl. G06F 17/60

(52) U.S. Cl. 705/26

(57) ABSTRACT

An interacting ordering method with a function of re-directing returning profits comprises the steps of: registering to a shopping network association; wherein the registers includes users, i.e., buyers, and sellers; providing platforms, commodity resources and management databases to the registered users and sellers by the shopping network association; building a connection between the user and the shopping network association through a network browser; clicking an icon on the frame representing a network of the seller registered to the shopping network association; displaying a frame to the user; selecting desired commodities and paying fees by using clicking related icons on the frame; determine a return profit about the transaction and displayed the returning profit on the frame; and paying the returning profit directly to the virtual account of the user or to the virtual account of another user by an allowance from the user buying the commodity.

### FIELD OF THE INVENTION

The present invention relates to electronic business, and more particular to an interacting ordering method with a function of re-directing returning profits to other group.

### BACKGROUND OF THE INVENTION

With the advance of technology, electronic business through Internet is a popular business model in the current society. However in current electronic business, the business is performed between the buyer and the commodity providers, i.e., a seller. In some cases, the providers can give a discount to the buyers due to some reasons. In this specification, we call the discount is a returning profit. It is possible that the buyer desires to transfer the returning profits to others, such as a school to which he or she ever attended. However the prior art electronic business does not afford the function for returning profits or transferring returning profits to others. Moreover, if a charitable institution hopes to raise money through the electronic business, the prior art design cannot achieve the object.

### SUMMARY OF THE INVENTION

Accordingly, the primary object of the present invention is to provide an interacting ordering method with a function of re-directing returning profits which can improve the defect in the prior art so as to provide functions which can give returning profits to users or transfer the returning profit to others.

To achieve above object, the present invention provides an interacting ordering method with a function of re-directing returning profits comprising the steps of: registering to a shopping network association; wherein the registers includes users, i.e., buyers, and sellers; providing platforms, commodity resources and management databases to the registered users and sellers by the shopping network association; building a connection between the user and the shopping network association through a network browser; clicking an icon on the frame representing a network of the seller registered to the shopping network association; displaying a frame to the user; selecting desired commodities and paying fees by using clicking related icons on the frame; determine a return profit about the transaction and displayed the returning profit on the frame; and paying the returning profit directly to the virtual account of the user or to the virtual account of another user by an allowance from the user buying the commodity.

The various objects and advantages of the present invention will be more readily understood from the following detailed description when read in conjunction with the appended drawing.

### BRIEF DESCRIPTION OF THE DRAWINGS

FIG. 1 shows the order process of the present invention.

FIG. 2 shows the structure of the shopping network association of the present invention.

FIG. 3 is a schematic view for the network browser of the registered group according to the present invention.

FIG. 4 is a schematic view showing an order of the shopping network association of the present invention.

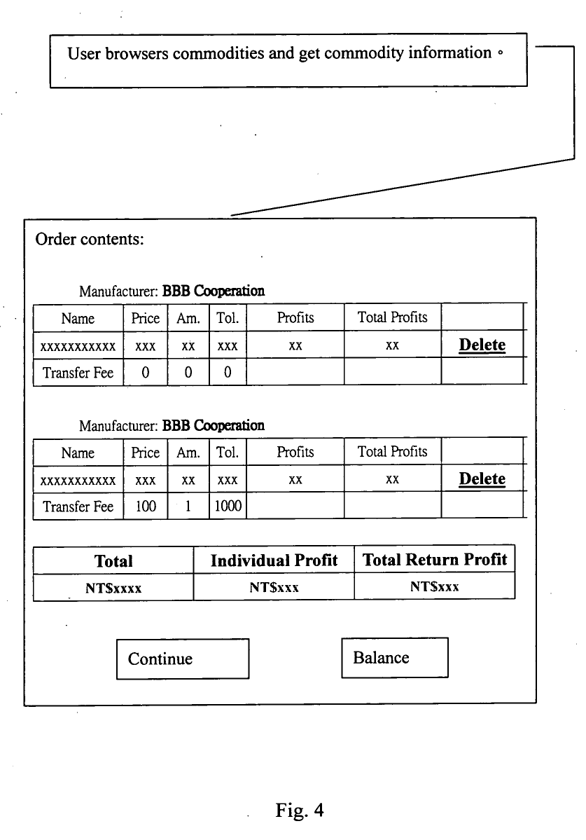

FIG. 5 is a schematic view showing the paying menu of the shopping network association of the present invention.

FIG. 6 is a schematic view showing a menu of paying returning profit of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

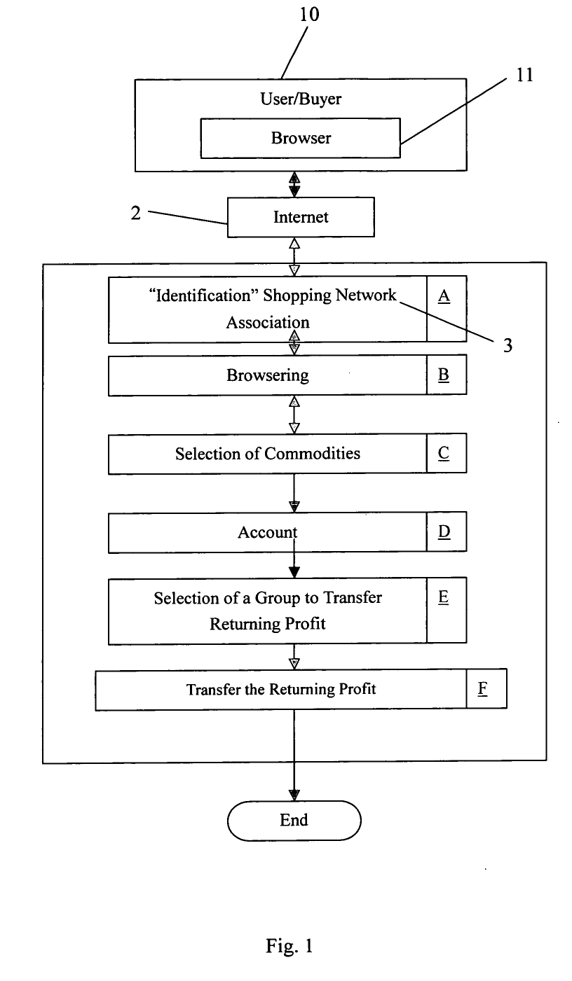

A network shopping using identification mechanism is illustrated in FIG. 1. In the mechanism, a user (or a buyer) 10 is registered to a shopping network association 3 through a network browser 11. Messages are transferred between the user and the shopping network association 3 through an Internet 11. Thereby, the user can read messages on the shopping network association 3. When the user is connected to the network, the action can be transferred to the shopping network association 3. Thus, the user acts as a client end and the shopping network association 3 is as a server end. The connection of the client end and the server end is known in the prior art, and thus the details will not further described here.

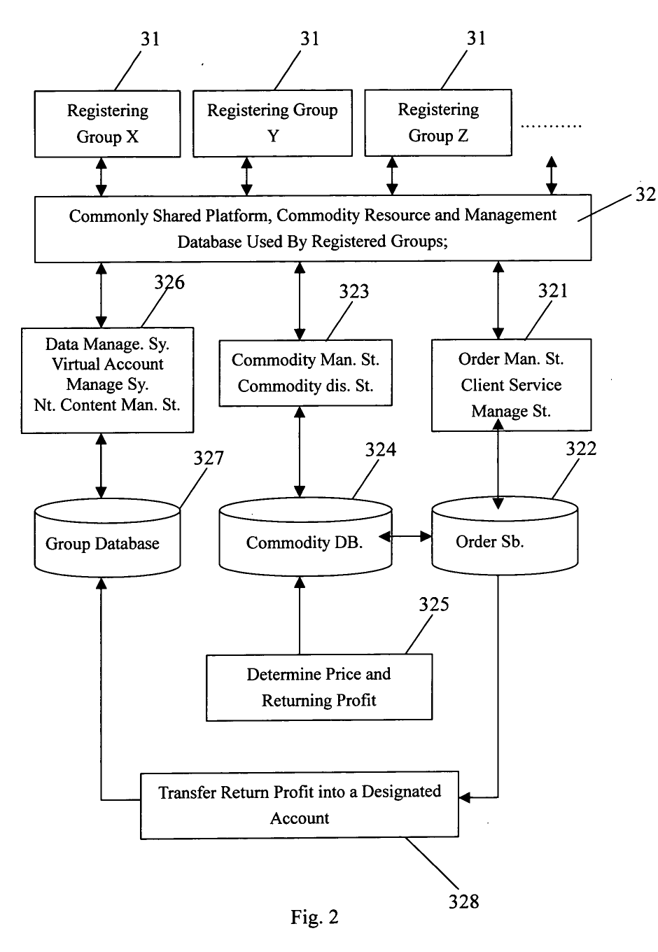

With reference to FIG. 2, the shopping network association 3 makes alliances with different buyers and sellers. Each of the buyers and sellers has a respective network station. Thus, the commodity messages of the sellers can be provided through the network station if each of the buyers and sellers adapts platforms, commodity resources and management databases 32 provided by the shopping network association 3.

The resource provided includes: 1. an order management system, a client service system 321, and an order database 322; 2. a commodity ordering management system; a commodity selling management system 323, a commodity database 324, and a commodity price and discount of the order identification 325; 3. A group (signing unit) data management system, a virtual account management system 323, a network content management system 326, and an identified group database 327.

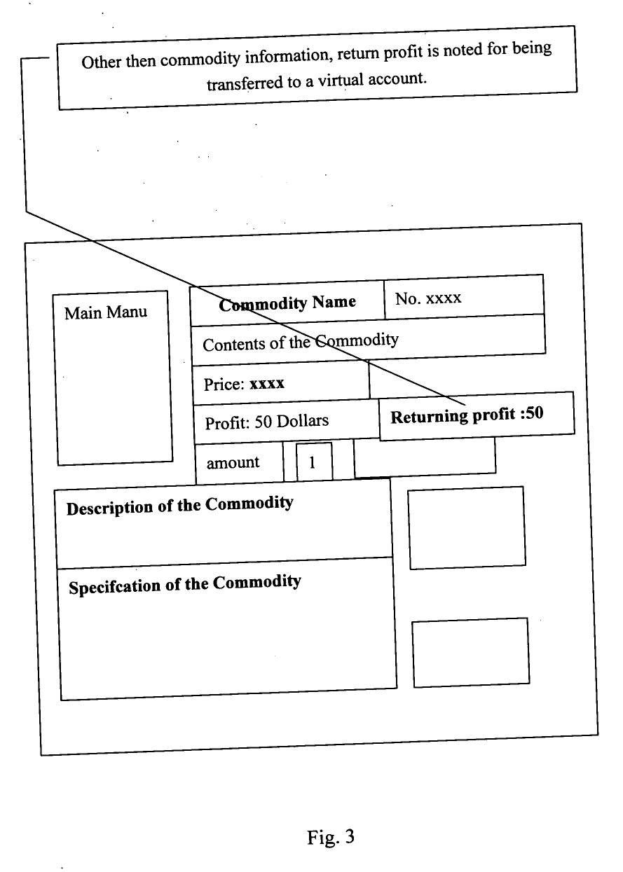

By this platform, the user can surf to the shopping network association 3 through a network browser 1 to click a network of the seller registered to the shopping network association 3. A frame displayed to the user 10 includes a menu for reading the data of all the commodities (referring to FIG. 3) and the operation of the network station.

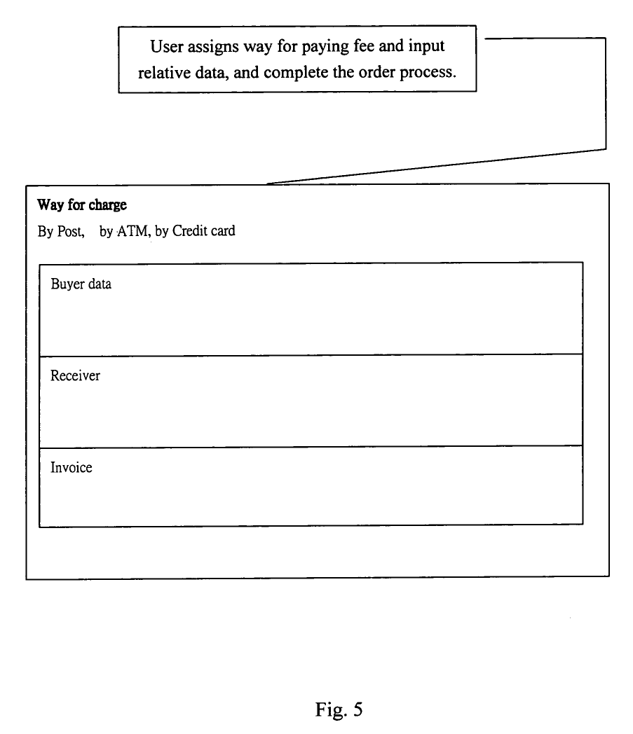

After clicking the commodity messages, the user 10 selects desired commodities. After buying, the fees are pay according to the process shown in FIG. 5, and the related fields are inputted so as to complete the ordering process.

In getting the order, the system calculates the charge of the order, and determine a return profit about the transaction. The returning profit is displayed on the frame and is pay directly of the virtual account of the group.

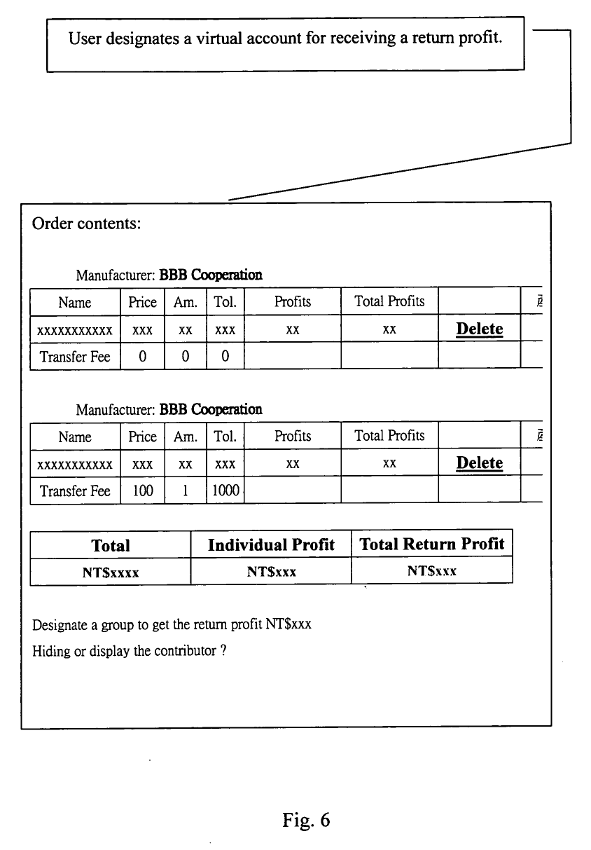

Referring to FIG. 6, a mode for processing the returning profit is illustrated. The returning profit can be transferred to a virtual account of another group by clicking the icon shown on the frame and representing the group 328.

By above said ordering process, the group can accumulate the returning profits from other groups through the platform of the shopping network association 3. Thereby, the groups having same object can interact through the platform.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. An interacting ordering method with a function of re-directing returning profits comprising the steps of:
registering to a shopping network association; wherein the registers includes users, i.e., buyers, and sellers; each of the users and buyers has a respective network station;
providing platforms, commodity resources and management databases to the registered users and sellers by the shopping network association so that the shopping network association provides the commodity messages of the sellers through the network station;
building a connection between the user and the shopping network association through a network browser;
clicking an icon on the frame representing a network of the seller registered to the shopping network association;
displaying a frame to the user; wherein the frame includes a menu for reading the data of all the commodities and the operation of the network station;
selecting desired commodities and paying fees by clicking related icons on the frame;
determine a return profit about the transaction and displayed the returning profit on the frame; and
paying the returning profit directly to the virtual account of the user.

2. The interacting ordering method with a function of re-directing returning profits as claimed in claim 1, wherein the resource provided includes: an order management system, a client service system; an order database; a commodity ordering management system; a commodity selling management system, a commodity database; a commodity price and discount of the order identification; a group data management system, a virtual account management system, a network content management system, and an identified group database.

3. An interacting ordering method with a function of re-directing returning profits comprising the steps of:
registering to a shopping network association; wherein the registers includes users, i.e., buyers, and sellers; each of the users and buyers has a respective network station;
providing platforms, commodity resources and management databases to the registered users and sellers by the shopping network association so that the shopping network association provides the commodity messages of the sellers through the network station;
building a connection between the user and the shopping network association through a network browser;
clicking an icon on the frame representing a network of the seller registered to the shopping network association;
displaying a frame to the user; wherein the frame includes a menu for reading the data of all the commodities and the operation of the network station;
selecting commodities to be bought by the user and paying fees by clicking related icons on the frame;
determine a return profit about the transaction and displayed the returning profit on the frame; and
paying the returning profit directly to a virtual account of another user by an allowance from the user buying the commodity.

4. The interacting ordering method with a function of re-directing returning profits as claimed in claim 3, wherein the resource provided includes: an order management system, a client service system; an order database; a commodity ordering management system; a commodity selling management system, a commodity database; a commodity price and discount of the order identification; a group data management system, a virtual account management system, a network content management system, and an identified group database.
